(19) United States
(12) Patent Application Publication
(10) Pub. No.: US 2019/0217387 A1
(43) Pub. Date: Jul. 18, 2019

(54) CONFINING MATERIAL DURING ADDITIVE MANUFACTURING PROCESSES

(71) Applicant: The Curators of the University of Missouri, Columbia, MO (US)

(72) Inventors: Heng Pan, Rolla, MO (US); Brandon Ludwig, Rolla, MO (US); Wan Shou, Rolla, MO (US)

(21) Appl. No.: 16/336,972

(22) PCT Filed: Sep. 25, 2017
(86) PCT No.: PCT/US2017/053201

§ 371 Date: Mar. 27, 2019

Related U.S. Application Data
(60) Provisional application No. 62/400,445, filed on Sep. 27, 2016.

(51) Int. Cl. B22F 3/105; B33Y 10/00; B33Y 30/00; B29C 64/153; B29C 64/205; B23K 26/342

(52) U.S. Cl. CPC B22F 3/1055; B33Y 10/00; B33Y 30/00; B33Y 80/00; B29C 64/205; B23K 26/342; B29C 64/153

(57) ABSTRACT

Confining material particles during laser irradiation of the particles at ambient atmospheric pressure for additive manufacturing. In an embodiment, an optically transparent press permits transmitting a laser beam through the press to process material particles while simultaneously applying pressure to the particles. Confinement of material particles assists laser processing by providing densification, providing planarization, reducing the gap for material evaporation and transfer to a substrate, and the like.

### CROSS REFERENCE TO RELATED APPLICATION

This application claims the benefit of U.S. Provisional Patent Application No. 62/400,445, filed Sep. 27, 2016, the contents of which are incorporated by reference in their entirety for all purposes.

### TECHNICAL FIELD

Aspects of the present disclosure generally relate to the field of additive manufacturing techniques that utilize a laser to process powdered material.

### BACKGROUND

Conventional techniques for additively manufacturing electronic devices are incapable of resolution below 100 micrometers due to fine powder agglomeration during layer-by-layer deposition. Using material solutions is undesirable because of the difficulty of preparing stable colloidal suspensions for reactive metals. Material solutions are also limited to two-dimensional fabrication. Moreover, solvents pose environmental concerns and electronic devices manufactured from them must be recycled or have the solvents removed.

Furthermore, conventional techniques for fabricating bioresorbable electronic devices include complex, time-consuming vacuum-based integrated circuit processes that involve anhydrous surface micromachining on regular substrates followed by thin film transfer printing to bioresorbable substrates. These techniques require a vacuum because hydroxyl, oxygen, and nitrogen present in the atmosphere easily react with bioresorbable metallic materials, and the bioresorbable substrates are thermally unstable. Other techniques for fabrication of bioresorbable devices include a screen printing method to achieve conductive PCB traces through pastes of biodegradable powders. However, the conductivities achieved by these pastes (e.g., 5000 S m−1) are undesirable due to the presence of polymer binders and surface oxides. Additionally, the resolution of printable features is limited by the screen printing methods. Sintering of biodegradable metal nanoparticles has been attempted, but the highest conductivity achieved is ≈4×10⁴ S m−1. The formation of surface oxide layers during these sintering techniques prevents the further increase of conductivity.

### SUMMARY

Aspects of the disclosure incorporate confinement of material particles (e.g., zinc nanoparticles) during laser processing (e.g., melting, evaporation, sintering, etc.) of the particles at ambient atmospheric pressure (e.g., non-vacuum environment) for additive manufacturing. Confining the material particles assists the laser processing by providing densification of the particles, providing planarization of the particles, preventing flow and dewetting of melt materials, and reducing the gap for particle evaporation and transfer to a substrate. For example, these features circumvent the formation of surface oxide during the laser processing.

A system embodying aspects of the disclosure includes a deposition device, a laser, and an optically transparent press. The deposition device is configured to deposit powder particles on a substrate. The laser is configured to generate a laser beam for irradiating the deposited powder particles. The optically transparent press is configured to apply mechanical pressure to the deposited powder particles while they are irradiated by the laser beam. The laser beam irradiates the deposited powder particles through the optically transparent press.

A method embodying aspects of the disclosure includes depositing a first layer of powder particles on a substrate and/or an optically transparent press. The deposited first layer of powder particles are confined by the optically transparent press applying pressure to the particles. And the confined first layer of powder particles are irradiated by a laser beam transmitted through the optically transparent press.

Other objects and features will be in part apparent and in part pointed out hereinafter.

### BRIEF DESCRIPTION OF THE DRAWINGS

FIGS. 1A-1C illustrate an exemplary additive manufacturing system and process within which an embodiment of the disclosure may be incorporated.

FIG. 2 illustrates an exemplary process of additively manufacturing electronic devices by laser transfer sintering according to an embodiment.

FIGS. 3A and 3B illustrate an exemplary fabrication process according to an embodiment.

FIG. 3C illustrates an exemplary microstructure image of deposited zinc hexagonal crystal according to an embodiment.

FIG. 3D illustrates exemplary top and cross-section views of a substrate according to an embodiment.

FIG. 4A illustrates laser irradiated zinc nanoparticles according to an embodiment.

FIG. 4B illustrates unprocessed zinc film according to an embodiment.

FIG. 4C illustrates processed zinc film according to an embodiment.

FIG. 5 illustrates aspects of evaporation-condensation of zinc nanoparticles, according to an embodiment.

FIG. 6 illustrates zinc nanoparticles processed at a fixed scanning speed and varying laser power, according to an embodiment.

Corresponding reference characters indicate corresponding parts throughout the drawings.

### DETAILED DESCRIPTION

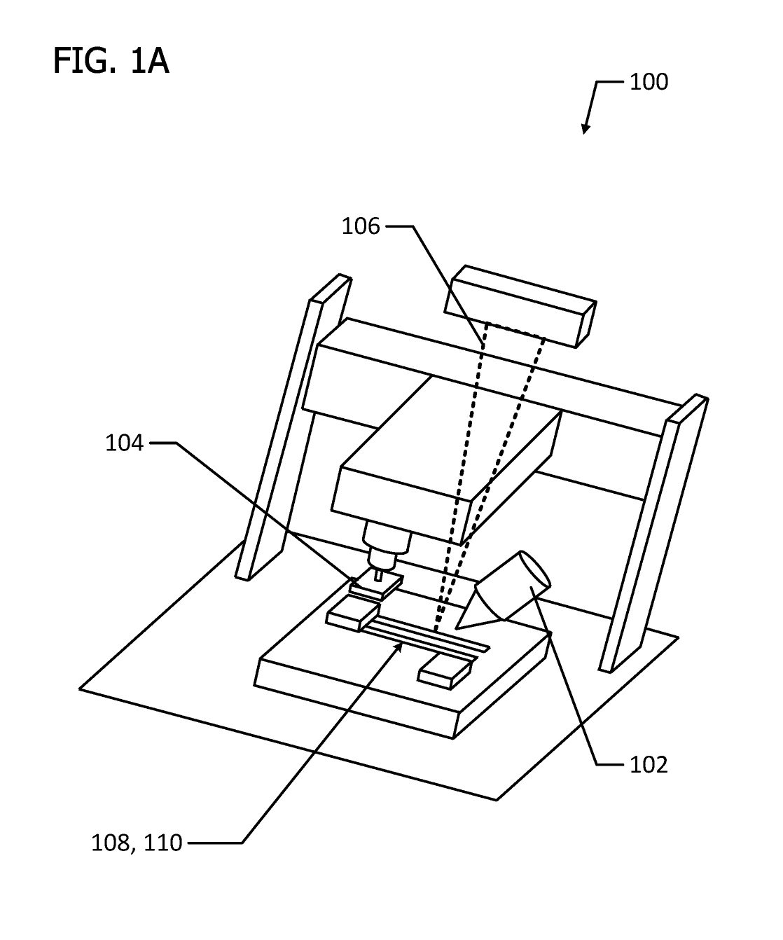

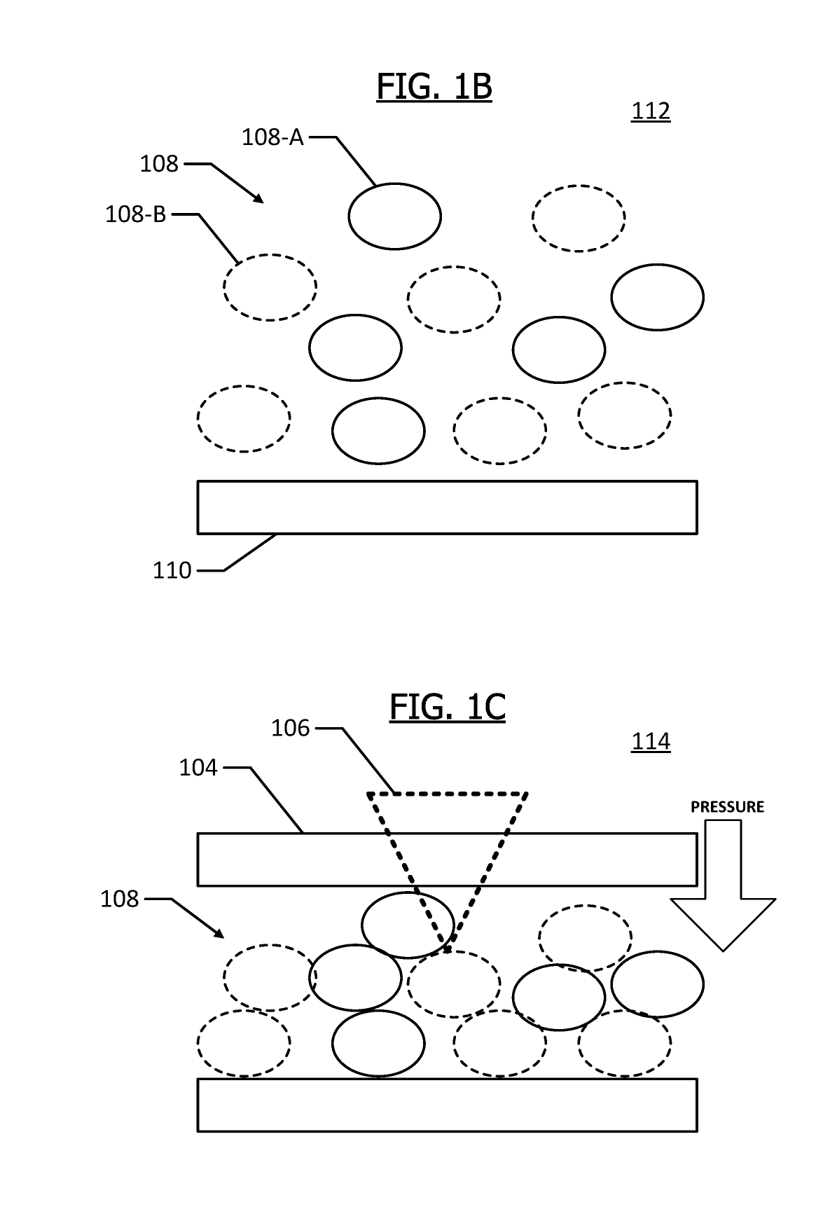

FIGS. 1A, 1B and 1C illustrate an exemplary additive manufacturing system and process, generally indicated at 100, within which an embodiment of the disclosure may be incorporated. The system 100 includes a deposition device (e.g., a sprayer or coater) 102, a press 104, and a laser 106. As further described herein, aspects of system 100 incorporate mechanical pressing (i.e., confinement) of powdered materials with laser selective processing of the materials.

The deposition device 102 is configured to deposit, at step 112, powder particles 108 on a substrate 110. In a preferred embodiment, the powder particles 108 are in dry form. However, one having ordinary skill in the art will understand that aspects of the present disclosure may also work with powder particles that comprise a (e.g., liquid) solution. In one form, powder particles 108 include active functional particles 108-A, illustrated in solid lines, and additive (e.g., binder, etc.) particles 108-B, illustrated in broken lines. In an embodiment, deposition device 102 comprises an electrostatic sprayer. The substrate 110 may be flexible and biodegradable in accordance with one or more embodiments of the disclosure.

The press 104 is configured to confine, at step 114, the deposited powder particles by mechanically pressing (e.g., applying pressure) the particles 108. The confinement assists laser processing by providing densification of powder particles 108, providing planarization of powder particles 108, preventing flow and dewetting of melt materials, reducing the gap for material evaporation and transfer, and the like. In an embodiment, press 104 comprises an optically transparent material, such as optically transparent glass and the like. The optically transparent material permits transmission of the laser 106 through the press 104 to provide thermal energy for sintering during pressing. In a further embodiment, the surface of the press 104 is coated with a coating (e.g., Teflon) to prevent adhesion of the powder particles 108 to the press. In accordance with an aspect of the disclosure, the pressing step (e.g., step 114) comprises aligning press 104 parallel to substrate 110. In an embodiment, the pressing is accomplished by a hydrostatic press, an air bag, a spring loaded press, or the like. In another embodiment, sensors measure the pressure, gap, and parallelism between plates and the measurements are used for process control, for example.

The laser 106 is configured to generate a laser beam for processing powder particles 108. Exemplary processing of powder particles 108 by laser 106 includes melting, evaporation, sintering, transferring of the particles, and the like. In an embodiment, the laser beam is scanned across powder particles 108 for selective laser sintering (SLS).

In an embodiment, system and process 100 incorporate confinement (i.e., mechanical pressing) during laser processing (e.g., SLS) of powder particles 108 (e.g., micro or nanomaterial particles) to fabricate two-dimensional or three-dimensional electronic components (e.g., sensors, conductors, batteries, solar cells, bioresorbable electronic devices, etc.). The incorporation of confinement with laser processing enables certain materials to be printed via additive manufacturing processes. For example, volatile metal particles can be evaporated and printed in a spatially confined domain in which confinement results in a small gap between the material (e.g., powder particles 108) and the substrate (e.g., substrate 110) to facilitate vapor transfer and deposition, as further described herein. Moreover, particles with binders (e.g., binder particles 108-B) can be melted and pressed (e.g., via press 104) to form solid composite electrodes.

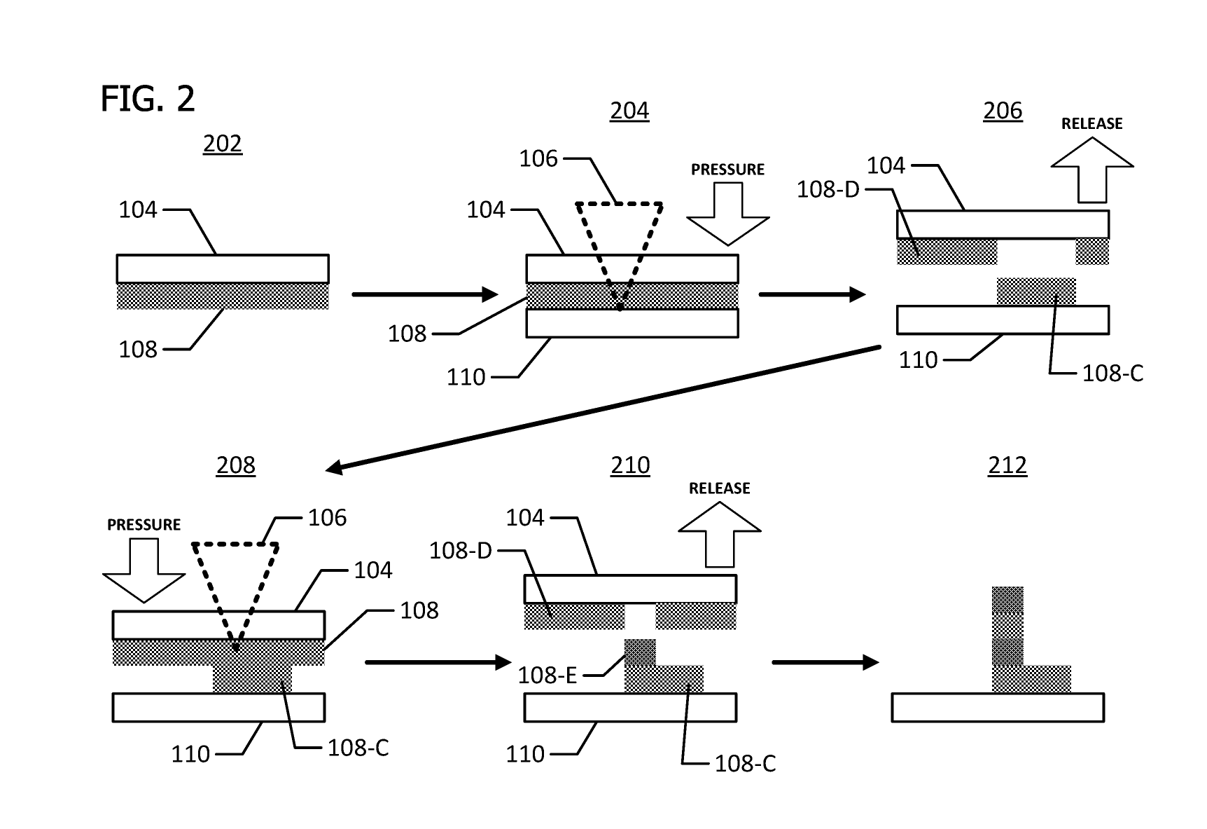

FIG. 2 illustrates an exemplary process of additively manufacturing electronic devices in a layer-by-layer manner by laser transfer sintering according to an embodiment of the disclosure. At step 202, powder particles 108 are deposited on press 104. In an embodiment, powder particles 108 are microparticles and/or nanoparticles and press 104 is optically transparent. In another embodiment, powder particles 108 are deposited on substrate (i.e., a receiver) 110. At step 204, press 104 applies mechanical pressure to powder particles 108 in the direction of substrate 110 while laser 106 processes (e.g., irradiates) the particles. In an embodiment, the pressure applied by press 104 is as high as pressure in hot pressing (e.g., from about 2 kilopascals up to about 2.5 megapascals). Advantageously, confining powder particles 108 via press 104 enables laser 106 to induce evaporation of powder particles 108 to substrate 110 at atmospheric pressure (i.e., a vacuum is not required). During step 204, particles 108 sintered by laser 106 evaporate and transfer to substrate 110.

At step 206, press 104 is released. The evaporated particles 108-C remain on substrate 110 while particles 108-D that were not sintered by laser 106 remain deposited on press 104 (e.g., via electrostatic charge). The particles 108-C that evaporated from press 104 during step 204 may be replaced by new particles. At step 208, press 104 again applies mechanical pressure to particles 108 in the direction of substrate 110 while laser 106 processes the particles. In an embodiment, particles 108 sintered by laser 106 during step 208 overlap with previously evaporated particles. The particles 108 sintered during step 208 evaporate and transfer to the previously evaporated particles 108-C instead of substrate 110. In this manner, aspects of the disclosure enable three-dimensional printing of electronic devices. At step 210, press 104 is again released and the evaporated particles 108-E remain on the previously evaporated particles 108-C while particles 108-D that were not sintered during step 208 remain deposited on press 104. The aforementioned steps may be repeated until printing of an electronic device 212 is complete.

In an embodiment, aspects of the disclosure utilize solvent-free particles 108. For example, functional micro/nanopowders (e.g., metal, oxide, and semiconductor) are mixed with nano-binders (e.g., polymer) and deposited layer-by-layer. In this embodiment, selective laser sintering is used to melt binder and bond functional powders together to fabricate electrical components via additive manufacturing.

In one form, aspects of the present disclosure can utilize a wider range of materials for manufacturing electronic devices than what conventional techniques can use. For example, a wide range of materials are available or can be prepared in nano-powder form, while extra processing steps are required to prepare stable colloidal suspensions. Moreover, reactive metals (e.g., zinc, magnesium, lithium, etc.) are more readily utilized in dry form. In another form, aspects of the present disclosure permit three-dimensional fabrication of electrical devices, as opposed to solution-based processes that are essentially two-dimensional. In yet another form, aspects of the present disclosure are environmentally friendly because there is no need to remove or recycle solvents in electronic devices manufactured in accordance with the disclosure. In an additional form, aspects of the present disclosure permit additively manufacturing three-dimensional micro-batteries with high feature resolution (e.g., less than 50 micrometers) and overcome the shortcomings of conventional slurry-based (e.g., printing or nozzle extrusion) processes. In yet another form, aspects of the present disclosure permit arbitrary three-dimensional structuring of piezo components with variable compositions.

The following description describes an exemplary vacuum-free transient electronics fabrication method based on simultaneous laser-induced confined vaporization, deposition, and sintering of active metal (zinc) nanoparticles, in accordance with an aspect of the disclosure.

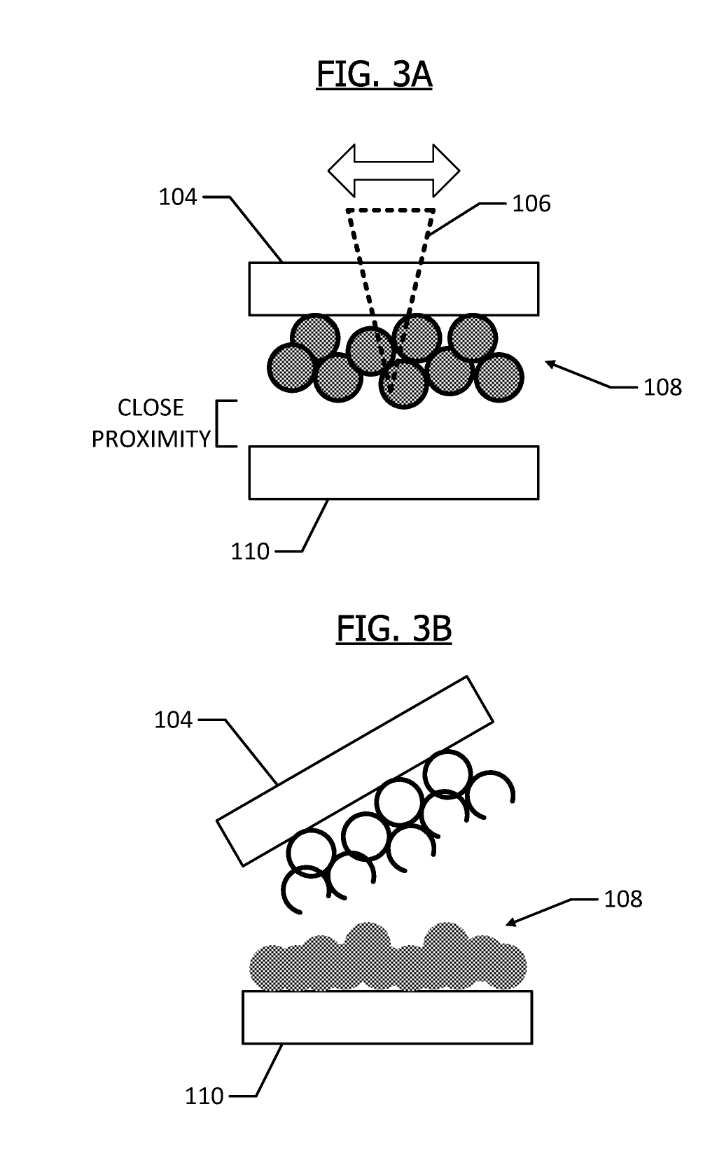

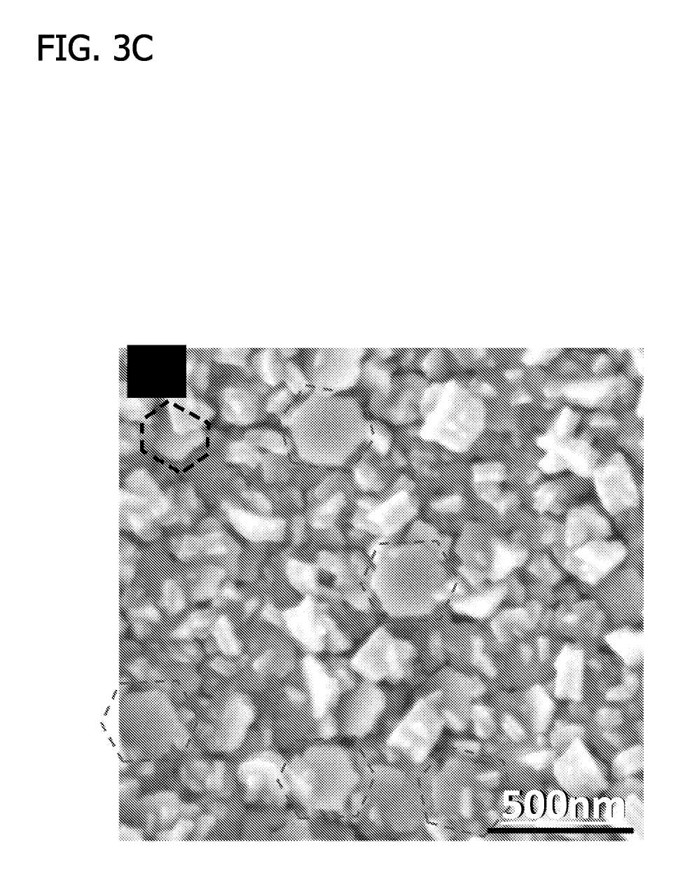

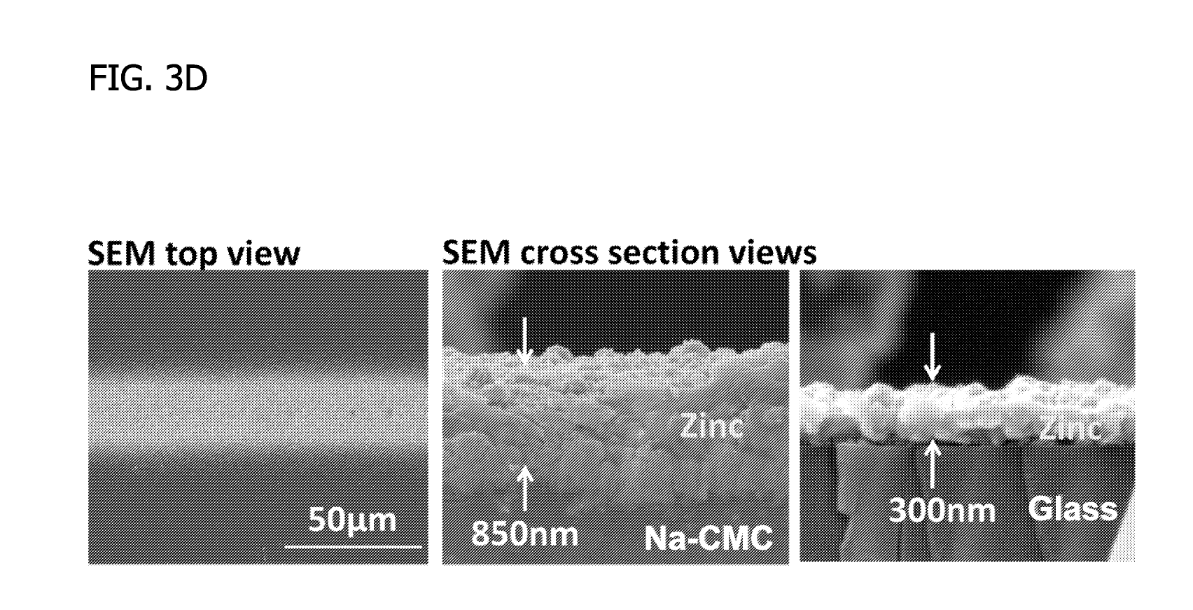

FIGS. 3A and 3B illustrate an exemplary fabrication process and configuration of the laser-induced confined evaporation of zinc nanoparticles. One having ordinary skill in the art will understand that FIGS. 3A and 3B are not to scale. The zinc nanoparticles 108 are dispersed in methanol and casted on a transparent glass slide 104 to form a zinc nanoparticle film of thickness about 2-3 micrometers after drying. The glass slide 104 coated with zinc nanoparticles is gently pressed onto a sodium carboxymethylcellulose (Na-CMC) substrate 110 with nanoparticles facing the surface. One having ordinary skill in the art will understand that substrate 110 may be comprised of other materials. The pressing creates a confined domain. In an embodiment, the zinc nanoparticles 108 are not pressed completely into Na-CMC substrate 110, but instead are pressed to within a close proximity (e.g., about 0.01 microns up to about 200 microns) of Na-CMC substrate 110.

The Na-CMC substrate 110 is prepared by solution casting, which is water soluble and non-toxic. A continuous-wave (CW) fiber laser 106 having a wavelength of about 1070 nanometers is irradiated through glass slide 104 while glass slide 104 applies mechanical pressure to the zinc nanoparticles 108. In an embodiment, CW fiber laser 106 is driven by a galvanometer for high-speed scanning (e.g., up to about 800 mm/s). For example, laser 106 may be scanned horizontally, as indicated by the double-sided arrow. Referring to FIG. 3B, irradiating certain zinc nanoparticles 108 causes evaporation to Na-CMC substrate 110. The glass slide 104 is then removed, leaving the evaporated zinc nanoparticles 108 on Na-CMC substrate 110. In this manner, reflective zinc traces with high crystallinity, indicated by the zinc hexagonal crystals that are similar to zinc crystals with strong (0002) plane texture obtained by thermal evaporation in vacuum chambers, are directly printed on the receiving Na-CMC substrate 110. A representative microstructure image of deposited zinc hexagonal crystal obtained by scanning electron microscopy (SEM) is illustrated by FIG. 3C.

FIG. 3D illustrates representative SEM top and cross-section views of Na-CMC substrate 110 fabricated at 400 mW and 200 mm/s. The illustrated top and cross-section views reveal that zinc traces with a linewidth of about thirty micrometers and sub-micron thickness can be fabricated in accordance with aspects of the disclosure. Changing the power of laser 106, the scanning speed of laser 106, and/or the type of substrate 110 can adjust the linewidth and thickness of the printed zinc traces.

Two-dimensional patterns may be created by digital printing of zinc nanoparticles 108 in ambient conditions, in accordance with an aspect of the disclosure. Exemplary patterns include geometric shapes, barcodes, and logos. The exemplary patterns demonstrate the versatility of the confined evaporation process in accordance with an aspect of the disclosure. The particles may also be deposited in a large grid pattern on Na-CMC substrate 110, in an embodiment. For example, aspects of the disclosure enable a large scale fabrication (e.g., about the size of a palm of a human hand) of a transient device array on Na-CMC substrate 110 fabricated within tens of seconds. Accordingly, aspects of the present disclosure are scalable and may meet requirements of industrial scale production of transient electronic devices.

In an embodiment, both substrate 110 and conducting patterns thereon dissolve completely in distilled water in about eighty to ninety-five minutes. It is known that both zinc and zinc oxide (ZnO) will become zinc hydroxide (Zn(OH)₂) during dissolution, which is a metabolite material capable of being processed by humans. In this manner, electronic devices manufactured in accordance with aspects of the disclosure are biodegradable/bioresorbable and environmentally friendly.

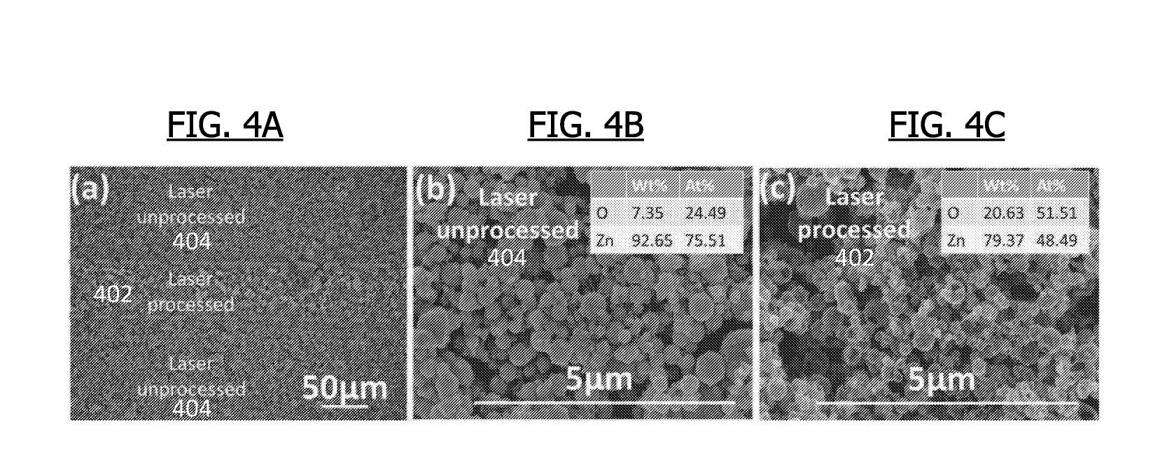

FIG. 4A illustrates the laser irradiated zinc nanoparticles 108 on glass slide 104 as imaged by SEM. The illustrated embodiment includes unprocessed and processed zinc film in argon. As illustrated, a clear contrast exists between areas processed (402) by laser 106 and areas unprocessed (404).

FIG. 4B illustrates a zoomed-in image of unprocessed zinc film 404 and FIG. 4C illustrates a zoomed-in image of processed zinc film 402. In the unprocessed zinc film 404 illustrated by FIG. 4B, zinc nanoparticles 108 are intact. In the processed film 402 illustrated by FIG. 4C, zinc nanoparticles 108 are hollow shell structures. In this manner, processing of zinc nanoparticles 108 by laser 106 changes the nanoparticles into hollow shell structures.

Energy-dispersive X-ray (EDX) spectroscopy results show that the unprocessed zinc nanoparticles 108 contain 7.35 wt % of oxygen, which corresponds to an atomic zinc to oxygen ratio of about 3:1, which corresponds to 20-30 nanometers native oxide. After processing by laser 106, the nanoparticles 108 exhibit a hollow shell structure and a significant increase in the oxygen and/or a decrease in the zinc, with a zinc to oxygen ratio of about 1:1. The formation of the hollow shell structure is independent of processing environment (e.g., ambient or argon). No obvious particle size variation was observed as a result of processing by laser 106 indicating that no significant coalescences occur due to laser heating. Zinc films laser printed in accordance with aspects of the disclosure contain 1.83 wt % of oxygen (i.e., lower than the zinc nanoparticles in the donor films) indicating that oxidation is largely suppressed during laser printing in accordance with aspects of the disclosure.

In an aspect, the hollow shell structure is formed due to the evaporation of the zinc core. Heating in a transmission electron microscopy (TEM) chamber induces evaporation of zinc and magnesium nanoparticles, leaving an oxide shell behind. Metal atoms escape from the oxide shell through pre-existing cracks or cracks developed during the heating as a result of mismatch in coefficient of thermal expansion (CTE). Mass conservation analysis reveals in order for zinc nanoparticles 108 having a size of about 100 nanometers (N=3.3×10² atoms) to be completely vaporized within the dwell time (τ) of laser 106 (e.g., about 0.1 milliseconds), the surface zinc flux is estimated=N/(4πR²)/τ=1×10²⁵ atom m⁻² s⁻¹. The vapor flux is estimated by J=σPₛₐₜ/(2πmk_{B}Tₛₐₜ)^{1/2}, where σ is the accommodation number ≈1, m is zinc atom mass 1.07×10⁻²⁵ kg, k_{B}=1.38×10⁻²³ m² kg s⁻² K⁻¹. For bulk zinc to reach flux ≈1×10²⁵ atom m⁻² s⁻¹, Tₛₐₜ needs to reach 850 K (Pₛₐₜ=974 Pa). In other words, the particles need to be ≈150 K higher than melting point (≈700 K). Accordingly, laser 106 heats the zinc nanoparticles 108 above the melting point (e.g., ≈850 K or above) in accordance with an embodiment of the disclosure.

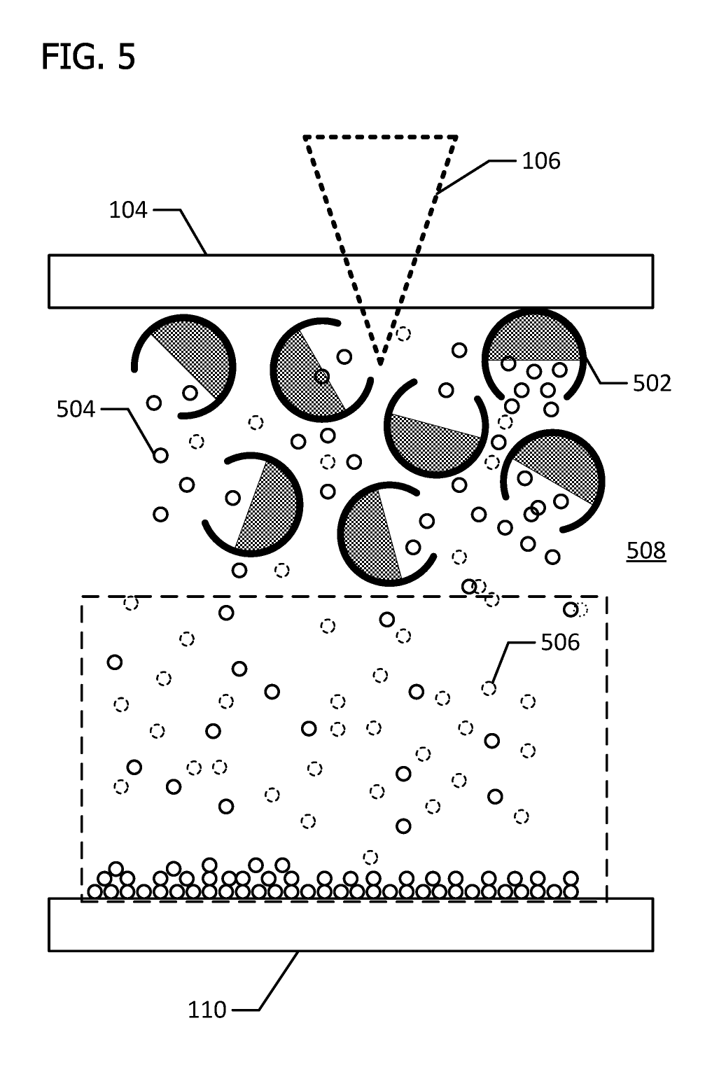

Due to the presence of the surface ZnO layer, the coalescence of zinc nanoparticles 108 is greatly retarded while evaporation of the core dominates, as illustrated by FIG. 5. The laser 106 processes particles 108 through optically transparent press 104. In an embodiment, laser 106 causes press 104 and particles 108 to heat up. Cracks form in the oxide shells 502, which allows the atoms (e.g., zinc atoms) 504 to escape (e.g., evaporate). The escaped zinc vapor atoms collide with background gas (e.g., argon) 506 at one atmospheric pressure before reaching the cold Na-CMC substrate 110 that provides a supersaturated condition of condensation. It can be estimated that the Zn—Zn collision frequency v_{Zn-Zn}=n_{zn}σv where n_{zn} is the concentration of Zn atoms, a is the cross-section, and v is the kinetic velocity. The diffusivity of zinc in inert gas (e.g., argon) is calculated to be about 1×10⁻⁴ m²/s using the Gilliland method. To diffuse zinc through a 10 micrometer gap takes about one microsecond. It can then be estimated that the number of collisions between Zn—Zn is 1 μs×v_{Zn-Zn}^{˜}11. Therefore, it is likely that the zinc atoms can reach substrate 110 without significant collision with other zinc atoms. In an embodiment, the zinc atoms reach substrate 110 without collisions by using a gap of less than ten micrometers. By using confinement in accordance with an embodiment of the disclosure, high crystallinity zinc nanocrystal film can be printed with a quality similar to vacuum-based thermal evaporation. The zinc hexagonal crystals (FIG. 3C) produced in accordance with an aspect of the disclosure are very similar to zinc crystals with strong (0002) plane texture obtained by conventional thermal evaporation techniques.

The gas rarefaction effect is considered to model heat transfer and temperature gradient through small gaps. The computed temperatures in zinc nanoparticle film reach >800 K for most of the laser scanning settings in accordance with an aspect of the disclosure. With proper selection of laser power and scanning speed, Na-CMC substrate 110 may be maintained below its degradation temperature. Reflective and undamaged traces can be obtained using these laser settings which substantiate thermal predictions. The calculated temperatures are then used to predict vapor flux and deposition rates. The vapor flux from zinc film can be computed using J=σPₛₐₜ/(2πmk_{B}Tₛₐₜ)^{1/2}. The emitted zinc atoms collide with argon gas molecules in a gap region 508 before reaching the cold Na-CMC substrate 110. Direct Simulation Monte Carlo (DSMC) predicts that exceptionally high metal deposition rate (1×10⁴-1×10⁷ nm s⁻¹) are achievable for evaporation through <10 μm gap distances. The predicted deposition rate is compared favorably with thickness as measured by SEM.

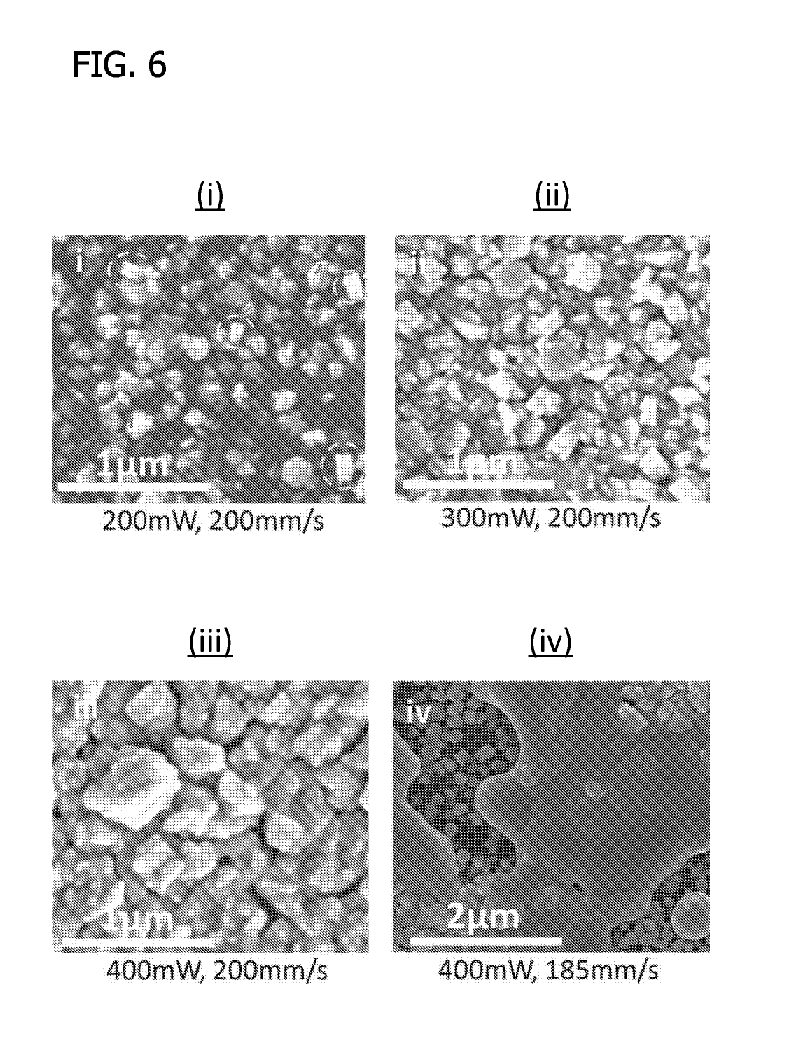

The above evaporation-condensation process occurs generally simultaneously with sintering of condensed zinc nanocrystals. Laser power and scanning speed influence the process. A test was firstly performed in an Argon enclosure at atmospheric pressure. With laser power at 400 mW, low speed (75 mm/s and 100 mm/s) tends to damage the substrate and high scanning speeds (500 mm/s) generate reflective metal traces. The scanning speed was then fixed at 200 m/s and laser power was gradually changed to identify four distinct processing regimes. With laser power at 200 mW, vapor condensation and formation of isolated small nanocrystals were observed (frame (i) of FIG. 6). The nanocrystals may have a horizontal or vertical deposition orientation, as illustrated. Increasing laser power to 300 mW, crystal growth of the nanocrystal was found (frame (ii) of FIG. 6). In the crystal growth regime, laser heating vaporizes more Zn and sustains the nanocrystal growth until large nanocrystals cover the entire substrate. Further increase in laser power leads to grain growth and sintering of nanocrystals (frame (iii) of FIG. 6). Finally, significant densification accompanied by pore formation was observed, indicated as densification regime in frame (iv) of FIG. 6. It is believed different morphologies determine the conductivity of fabricated traces. Due to the relatively good morphology obtained by 400 mW, the influence of scanning speed and fabricating environment on the conductivity was investigated. The highest conductivity is estimated to be 1.124×10⁶ S/m, which is 6.7% of bulk values (16.6×10⁶ S/m). The tests were repeated in air and similar results were found. It is noteworthy that this conductivity is two orders of magnitude higher than these reported in previous works using conventional techniques and near the conductivity obtained by direct laser writing (DLW) using silver and gold (2.2-5.56×10⁶ S/m). This result indicates that the fabricated zinc patterns on bioresorbable substrates can be readily integrated with high performance electronics.

In order to further increase the conductivity, a regular glass slide was utilized as the substrate such that lower scanning speeds could be tested without damaging the substrate. It was found employing 1 W laser power and relatively thick donor film (^{˜}5 μm) improved the conductivity.

In an embodiment, a system in accordance with aspects of the disclosure includes a sprayer or coater (102), a laser (106), and an optically transparent press (104). The sprayer or coater is configured to deposit powder particles (108) on a substrate (110). The laser is configured to generate a laser beam for irradiating the deposited powder particles. The optically transparent press is configured to apply mechanical pressure to the deposited powder particles during irradiation of the particles. The laser beam irradiates the deposited powder particles through the optically transparent glass.

In one form, the optically transparent press is comprised of glass. In another form, the optically transparent press comprises a glass with a coating (e.g., Teflon). In yet another form, the deposited powder particles are irradiated at an ambient atmospheric pressure. In another form, the powder particles are dry particles each having a diameter of less than fifty microns. In yet another form, the irradiation of the confined powder particles causes at least one of melting, evaporation, sintering, and transferring of the powder particles such that the particles form an electronic device. For example, the electronic device may be at least one of a sensor, a conductor, a battery, a solar cell, and a bioresorbable electronic device. In another form, the substrate and powder particles are bioresorbable.

In another embodiment, a method in accordance with aspects of the disclosure includes depositing (202) a first layer of powder particles (108) on at least one of a substrate (110) and an optically transparent press (104). The method also includes confining (204) the deposited first layer of powder particles by the optically transparent press applying pressure to the particles. The method also includes irradiating (204) the confined first layer of powder particles by a laser beam transmitted through the optically transparent press.

In one form, the irradiating comprises selective laser sintering. In another form, the method further includes releasing (206) the pressure applied to the confined first layer of powder particles by the optically transparent press, depositing another layer of powder particles on at least one of the substrate, the optically transparent press, and previously deposited particles, confining (208) the deposited another layer of powder particles by the optically transparent press applying pressure to the particles, and irradiating (208) the confined another layer of powder particles by the laser beam transmitted through the optically transparent press. In yet another form, the method further includes repeating the releasing, depositing another layer of powder particles, confining the deposited another layer of powder particles, and irradiating the confined another layer of powder particles to create a three-dimensional electronic device.

### Example

To evaluate the functionality and adhesion between laser printed zinc patterns and substrate, strain gauges were fabricated in accordance with aspects of the disclosure. The resistive zinc strain gauges to detect strains subjected to stretch and deflection were laser printed on Na-CMC substrate. The resistance increased from the original value (R0≈587Ω) by 0.1%-0.2% when applying linear strain 20.15%. The resistance restored to its original value after releasing the tensile stress. The gauge factor (GF) can be estimated to be ≈1.0, which is consistent with reported GF of thin evaporated metal films such as Au, Pt, Co, and Ni with resistance of 102-104Ω. No visual damage (such as delamination and cracking) or electrical degradation were observed after these stretch-release cycles. A strain gauge on cantilever beam to detect deflection was also fabricated and tested. The radius of curvature due to deflection was estimated to be ≈16 mm. Using ε=hs/(2Rb), where hs is the thickness of substrate (≈140 μm) and Rb is the nominal bending radius, the strain was estimated to be ≈0.44%. The measured strain was in good agreement with the estimated value by assuming a GF ≈1. The zinc grid conductor was also fabricated and integrated into an LED circuit to demonstrate its robustness and stability as a circuit component. Subjected to various bending and folding (e.g., “n” shape folding, 90 degree folding, etc.), the zinc conductors remained highly conductive and the LED lights stayed on throughout the entire testing, which implies robust structural integrity of the fabricated pat-tern. No appreciable cracks or channel cracks could be found on sample subjected to strain up to 10% implying strong adhesion between zinc and Na-CMC substrate. The above tests demonstrate that the as-fabricated device has good capability to be used as sensors for applications in pressure sensing, structural health-monitoring, mass measurement, and the like.

The Na-CMC substrate 110 described in the experimental study was comprised of Na-CMC particles with a molecular weight of 250,000. The Na-CMC particles were added to tap water by 2 wt %. Then the solution was stirred at 600 rpm until bubble-free. In an embodiment, the solution is stirred for about five to about six hours. After stirring, the solution was dried naturally in a Petri dish. In an embodiment, solution is added after 48 hours in order to make thick film.

The zinc nanoparticles 108 described in the experimental study had a diameter of about 65-75 nanometers produced by electrical explosion methods. Methanol and butyl acetate were first mixed with volume ratio of 9:1 as the solution for zinc nanoparticles. Zinc ink was prepared by mixing one gram of nanoparticle and four grams of the above solution to form 20 wt % turbid solution. The ink was sonicated for two 10 minute periods with a 5 minute gap in between before use. The zinc film was deposited on the glass slide by bar-coating.

The laser 106 described in the experimental study was a single mode ytterbium fiber laser (IPG, 1065 nm, CW, 100 Watt) and directed into a galvanometer for high speed (up to 800 mm/s) laser sintering and printing. The estimated laser spot size was 60-70 micrometers in diameter. For fabrication on Na-CMC substrate, various laser power levels (up to 0.5 Watt) and scanning speeds up to 500 mm/s were used. For processing on glass, laser power levels up to 1 Watt and speeds up to 100 mm/s were used. Most processes were performed in ambient air with several selected processes performed in an argon enclosure.

SEM images and EDX analysis described herein were taken in Hitachi S-4700 or Helios Nanolab 600. TEM images were taken on an FEI Tecnai F20 instrument. Strain gauge measurements (e.g., resistance) were conducted in Tektronix DMM4050 6-1/2 Digit Precision Multimeter. For strain gauge measurements, external wires were placed on zinc patterns and secured with copper tape. The contact was fixed by a clamp to ensure mechanically reliable connection during any stretching or deflection testing.

When introducing elements of aspects of the invention or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

1. A system, comprising:
a deposition device configured to deposit powder particles on a substrate;
a laser configured to generate a laser beam for irradiating the deposited powder particles; and
an optically transparent press configured to apply mechanical pressure to the deposited powder particles during irradiation thereof by the laser beam, wherein the laser beam irradiates the deposited powder particles through the optically transparent press.

2. The system of claim 1, wherein the optically transparent press is comprised of glass.

3. The system of claim 1, wherein the optically transparent press comprises a glass with a coating.

4. The system of claim 1, wherein the deposited powder particles are irradiated at an ambient atmospheric pressure.

5. The system of claim 1, wherein the powder particles are dry particles each having a diameter of less than fifty microns.

6. The system of claim 1, wherein the irradiation of the confined powder particles causes at least one of melting, evaporation, sintering, and transferring of the powder particles such that the particles form an electronic device.

7. The system of claim 6, wherein the electronic device is at least one of a sensor, a conductor, a battery, a solar cell, and a bioresorbable electronic device.

8. The system of claim 1, wherein the substrate and the powder particles are bioresorbable.

9. A method, comprising:
depositing a first layer of powder particles on at least one of a substrate and an optically transparent press;
confining the deposited first layer of powder particles by the optically transparent press applying pressure thereto; and
irradiating the confined first layer of powder particles by a laser beam transmitted through the optically transparent press.

10. The method of claim 9, wherein said irradiating comprises selective laser sintering.

11. The method of claim 9, further comprising:
releasing the pressure applied to the confined first layer of powder particles by the optically transparent press;
depositing another layer of powder particles on at least one of the substrate, the optically transparent press, and previously deposited particles;
confining the deposited another layer of powder particles by the optically transparent press applying pressure thereto; and
irradiating the confined another layer of powder particles by the laser beam transmitted through the optically transparent press.

12. The method of claim 11, further comprising repeating said releasing, said depositing another layer of powder particles, said confining the deposited another layer of powder particles, and said irradiating the confined another layer of powder particles to create a three-dimensional electronic device.

13. The method of claim 9, wherein said irradiating is at an ambient atmospheric pressure.

14. The method of claim 9, wherein said irradiating causes at least one of melting, evaporation, sintering, and transferring of the powder particles such that the particles form an electronic device.

15. The method of claim 14, wherein the electronic device is at least one of a sensor, a conductor, a battery, a solar cell, and a bioresorbable electronic device.

16. A method, comprising:
applying pressure, by an optically transparent press, to a first layer of powder particles to confine the first layer of powder particles;
transmitting a laser beam through the optically transparent press to irradiate the confined first layer of powder particles;
releasing the pressure applied to the confined first layer of powder particles by the optically transparent press;
applying pressure, by an optically transparent press, to a second layer of powder particles on the first layer of powder particles to confine the second layer of powder particles; and
transmitting the laser beam through the optically transparent press to irradiate the confined second layer of powder particles to create a three-dimensional additive structure.

17. The method of claim 16, wherein transmitting the laser beam selective laser sintering.

18. The method of claim 16, further comprising depositing the first layer of powder particles on at least one of a substrate and the optically transparent press.

19. The method of claim 18, further comprising depositing the second layer of powder particles on at least one of the substrate, the optically transparent press, and first layer of powder particles.

20. The method of claim 16, wherein the transmitting the laser beam causes at least one of melting, evaporation, sintering, and transferring of the powder particles such that irradiating the particles form an electronic device.
